(19) United States
(12) Patent Application Publication
(10) Pub. No.: US 2005/0152217 A1
(43) Pub. Date: Jul. 14, 2005

(54) Rotary drum for tablet coating with reverse-direction unloading

(76) Inventor: David O'Hara, Toronto (CA)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 10/801,022

(22) Filed: Mar. 15, 2004

(30) Foreign Application Priority Data
Jan. 14, 2004 (CA) 2,455,192

(51) Int. Cl. B01F 9/06

(52) U.S. Cl. 366/228; 366/233; 366/234

(57) ABSTRACT

A mixing device for tablets includes a rotating drum including front and rear end walls, with the front end wall having a central mouth to receive and discharge the drum contents. One or more ribbon-like baffles are mounted to the inside surface of the front wall, with the baffle having a distal end which partly occludes the drum opening. The baffles are mounted at an angle such that when the drum is rotating in one direction they tend to direct the contents of the drum towards the opening of the drum to discharge the drum contents in a series of successive drum rotations, while when the drum is rotated in the opposite direction the baffles tend to direct the contents of the drum away from the drum opening. One or more curved ribs mounted to the inside surface of the drum body at an angle may be provided to cooperate in the tablet mixing and discharge phases.

### CROSS-REFERENCE TO RELATED APPLICATIONS

This application claims the Paris Convention priority benefit of Canadian Patent Application Serial No. 2,455,192 filed Jan. 14, 2004.

### FIELD OF THE INVENTION

The invention relates equipment for manufacturing tablets, pills and other loose articles which require tumbling or mixing during their processing, and specifically to rotating drums used in such processing into which tablets may be loaded for a step involving tumbling, followed by unloading from the drum.

### BACKGROUND OF THE INVENTION

The manufacturing of tablets, such as for pharmaceutical use, generally requires at least one step in which the tablets are tumbled within a drum as they are being coated and/or dried. The tablets are then removed from the drum and deposited into a container for shipment. It is desirable to automate and simplify as much of this process as possible to minimize workers' exposure to the product (such as pharmaceuticals) as well as to reduce the manpower involved in these steps, and also to increase the product quality and consistency. Tumbling and mixing devices for this purpose generally comprise a large drum or pan that is mounted for rotation about a generally horizontal axis, with the drum being operatively linked to a means to rotate the drum. As the drum rotates, the contents of the drum are mixed and tumbled by the movement of the drum. The drum may have a perforated or mesh wall for drying of the tablets by directing a stream of air or other gas through the drum wall as the drum is being rotated. An aspect of this process which in the past has presented some difficulty is the safe removal of tablets from the drum after processing is complete. In small drums the removal of the contents may be done by hand. However, in larger horizontal drum mixers the removal of the contents of the drum by hand becomes burdensome in both time and effort. As well, hand removal potentially increases the risk of workers' exposure to the product. To address this problem, several devices have been designed to remove the contents of the drum by gravity feed or other means.

In one example of a drum-type tablet dryer (U.S. Pat. No. 3,937,176 to Nicholson et al.), the unloading device utilizes a scoop mounted within the drum, having at its lower end an inlet located inside the drum which scoops up the contents of the drum as the drum rotates and an outlet located outside the drum. When the drum rotates into a position such that scoop is in a low position some of the contents of the drum enter the inlet and then as the scoop rotates into a higher position it inverts and the contents flow out through the outlet located outside the drum. In this manner the drum contents are gradually removed. However, there exists a limit to the rotary speed of the drum in such a device as excessive speed may prevent the drum contents from entering the scoop. More importantly, the scoop is not intended to remain in place during the mixing process. Thus, the drum's rotation must be stopped, the chute attached and the drum must resume rotation with the chute in place until it is fully unloaded. To resume mixing again, the chute must be removed. This operational requirement slows down the process and adds to manpower requirements, as well as presenting a potential for worker's exposure to the product.

A rotatable mixing drum is disclosed in U.S. Pat. No. 2,625,903 to Opie, for use in a candy making process. This device includes a generally horizontally disposed rotatable drum having an internal baffle or rib for mixing loose articles within the drum and for shifting their position within the drum as the drum is rotated from the drum entrance at one side of the drum towards the exit at the other side, at which point they exit the drum. The dwell time of articles within the drum is determined largely by the rotary speed of the drum, which controls the rate at which the drum contents pass from one side of the drum to the other. One undesirable aspect of this arrangement (as well as other similar devices which rely on an internal auger-like member) is that the internal components tend to take up too much space within the drum and do not leave a clear space to permit the drum contents to freely tumble.

### SUMMARY OF THE INVENTION

This invention has as an object the provision of an improved drum-type mixing or tumbling device (and individual components of such a device) for processing of tablets and other similar small loose articles. It is a further object to provide such a device wherein the drum may be rotated about its elongate axis in a first direction for mixing and in an opposite direction for unloading, without the need to manually rearrange any components of the system or otherwise come into contact with the drum during processing. It is a further object to provide a device of this type in which minimal damage to the tablet occurs during normal operation of the device during the unloading stage.

This invention utilizes a generally horizontally-disposed drum (i.e., its elongate axis being horizontal) having a system of internal baffles and ribs to help tumble the contents of the drum when the drum rotates about its elongate axis in a first direction and to unload the drum through an opening in an end wall of the drum when the drum rotates in the opposite direction.

In one aspect, the invention includes a drum comprising a cylindrical drum wall and front and rear end walls, with the front end wall being annular in shape with a central mouth which communicates with the drum interior. At least one and preferably two ribbon-like baffles are mounted to the inside surface of the front end wall to protrude into the drum interior. The baffles are relatively elongate and thin, with two opposed flat sides and narrow edges, such that each baffle is mounted to the inside surface of the drum along one of the narrow edges of the baffle. The baffle is both arcuate and twisted along substantially its full length. At its proximal end the baffle meets the cylindrical drum wall (either being in contact with or adjacent to the drum wall) and effectively scoops up the drum contents as the drum rotates, in a manner such that a relatively small amount of the drum contents is scooped up with each drum rotation. At the opposed (distal) end of the baffle (at the drum mouth), the baffle partly occludes the drum mouth. At this end, the baffle comprises a generally flat paddle-like member which is folded inwardly relative to the overall arcuate shape of the baffle for pushing tablets out of the drum mouth as the tablets slide along the baffle. Rotation of said drum in a first direction, which preferably is around a generally horizontal axis of rotation, tends to cause the baffle to direct the drum contents (to the extent that stray tablets contact the baffle) inwardly away from said mouth for tumbling of the drum contents while preventing inadvertent spillage of the drum contents from the drum mouth. However, rotation in a second opposed direction causes said baffle to scoop the drum contents from the interior of the drum, with the drum contents then sliding along a side surface of the baffle for discharge from said mouth upon continued rotation of the drum. The contents are scooped up in sequential rotations of the drum, wherein the drum contents are emptied gradually over the course of a plurality of rotations. The tablets may be deposited into a discharge chute, storage container, etc.

Preferably, the front end wall is generally conical in shape and protrudes outwardly from said drum.

Preferably, an array of arcuate and twisted ribs is mounted on the inside surface of the cylindrical wall of the drum communicating with the baffle. Each rib is preferably generally angularly displaced from a radius of the drum body and its end walls, that is, it generally parallels a chord of the end wall. The communication of the rib and baffle is effected by positioning these two elements such that the respective ends thereof are either abutting or nearly abutting in end-to-end relationship, such that when the drum rotates in the second direction, the drum contents are urged by the rib towards the baffle, which in turn receives the contents and effectively serves as a trough along which the drum contents may slide outwardly from the drum as the same rotates. In the preferred version, the drum is provided with at least two baffles and ribs.

The invention may also include one or more rear ribs mounted to the rear end wall of said cylindrical drum to assist in the tumbling process.

The invention may also include the surrounding environment of the drum to rotatably support and drive the drum in a horizontal position. Thus, the invention may include means for supporting and rotating said drum such that the axis of rotation is substantially horizontal, such as a motor, force transfer means to transfer rotary movement of said motor into rotation of said drum, and a reverser to selectively reverse the direction of rotation of said drum upon actuation.

It is the discovery of the inventors that a suitably-shaped and relatively shallow system or array of ribbon-like baffles mounted to the end wall of a drum, which protrude minimally into the drum interior, optionally in tandem with an internal rib system as described above, will effectively unload the drum with repeated rotations of the drum. This unloading process may be accomplished within a suitable time for commercial processing operations. The system does not interfere with the tumbling process and in fact may assist it when the drum is rotating in the first direction by directing stray tablets back into the drum interior.

It will be understood the term “tablets” used herein is intended to cover any small article that is suitable for processing in the invention, including without limitation pills, capsules, granules, pellets, etc. without restriction as to the configuration of the articles. It will be further understood that direction references such as “vertical”, “horizontal”, “upright”, etc. are intended to cover a degree of departure therefrom. One skilled in the art would recognize that the amount of departure which will still permit the invention to operate as described herein may be easily determined by routine testing. As well, directional references are for convenience of description and are not intended to limit the positions in which the device may be placed unless specifically so stated. In reference to the ribs and baffles described herein, for convenience these are generally described as if they were positioned vertically. Hence, the term “thickness” refers to the distance between opposed broad lateral (upright) sides while “height” refers to the distance between the upper and lower edges or surfaces.

### BRIEF DESCRIPTION OF THE DRAWINGS

FIG. 1 is a schematic view of a mixing device according to the present invention, with the drum being shown as partially transparent to illustrate the internal components.

FIG. 2 is a side elevation view of a drum according to the present invention.

FIG. 3 is a schematic view from line A-A of FIG. 2, showing the interior of the drum.

FIG. 4 is an isometric view of the drum, with the drum wall being shown as transparent illustrate the drum interior.

FIG. 5 is a schematic wire diagram of the drum nose cone and baffle array, shown as a side elevational view.

FIG. 6 is a side elevational view of the baffle.

FIG. 7 is a front plan view of the rib.

FIG. 8 is a plan view of the rib.

### DETAILED DESCRIPTION

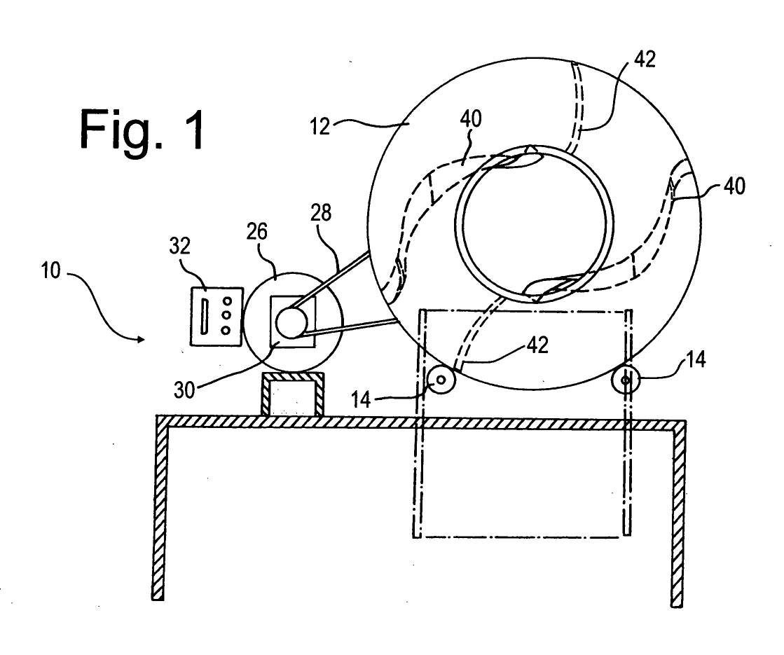

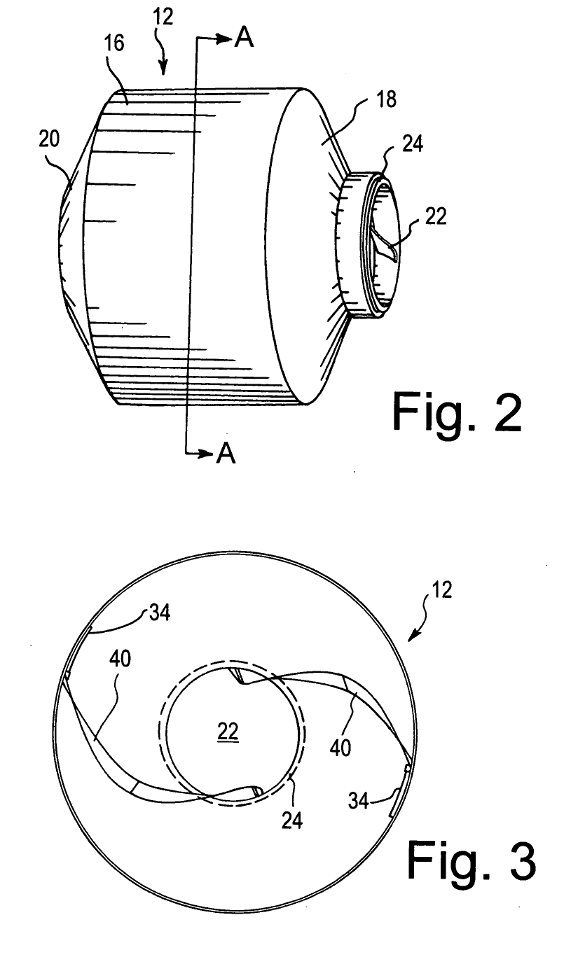

A schematic illustration of a tablet mixing device 10 according to the present invention is shown in FIG. 1, comprising in general terms of a drum 12 mounted horizontally (i.e. with its elongate axis being horizontal) for rotation about a generally horizontal axis. The drum may be journaled for rotation by any convenient means, such as supporting the drum on a plurality of rotatable wheels 14. The term “generally horizontal” refers to the preferred orientation of the drum. However, it will be understood that the axis of rotation may depart from the horizontal; it will be seen that the optimal orientation of the drum in any particular embodiment of this invention may be determined by routine experimentation by one skilled in this field. The drum may comprise any suitable pharmaceutical processing drum, although it is preferred that the drum be fabricated from stainless steel and include perforations within its cylindrical wall in order to direct an airstream therethrough for rapid and even drying of the drum contents during tumbling. The drum comprises a cylindrical drum body 16 defined by a cylindrical wall, capped at its front and rear ends by a front nose cone 18 and a rear wall 20. The rear nose cone 20 fully covers the rear opening of the drum and the front nose cone 18 has a central circular opening 22 communicating with the drum interior for introducing and removing the drum contents for processing within the drum. The front nose cone 18 is generally conical in shape and protrude outwardly. The rear wall 20 may comprise any convenient shape, including a conical shape as shown. A cylindrical collar 24 surrounds the central front opening and protrudes outwardly therefrom. The depth of the drum body (not including the front and rear nose cones) may be about 39 inches, with the drum body diameter being 48 inches.

The drum may be rotatably driven by any convenient means known to the art. In the example illustrated, an electric motor 26 is operatively linked to the drum via a drive belt 28, which in turn joins with a pulley mounted on the rear wall of the drum (not shown). The belt 28 is operatively connected to the motor 26 via a reversible gear box 30 which permits the operator to reverse the direction of rotation of the drum. As well, conventional speed and other operational controls 32 are provided to control the speed and direction of rotation of the drum. Automated controls may be provided to provide for automated operation of the system, or to link operation of the system to other aspects of the processing operation.

The device may be enclosed within a housing, not shown, which may also contain conventional elements such as sprayers, blowers, heaters etc. The housing preferably includes a closable lid, not shown, to seal the drum opening during the mixing stage of the drum's operation. The drum opening 22 may also communicate with a conventional discharge chute, also not shown.

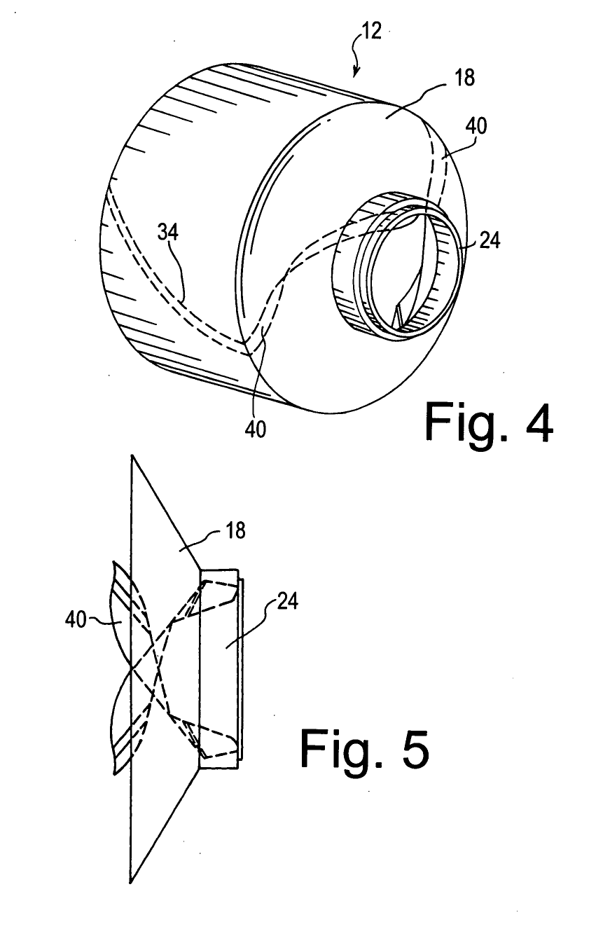

As seen in FIGS. 4, 7 and 8, two opposed ribs 34 are mounted to the interior surface of the cylindrical drum body. These preferably do not significantly protrude into the drum interior. Hence, in a non-limiting example the ribs are 34 are relatively broad and shallow, for example about ⅝ inches tall and ¾ inches thick. The ribs 34 are arcuate along their length and twisted along their long axis and are mounted to the inside surface of the drum body on a bias wherein the ribs 34 are disposed at a non-right angle relative to the elongate axis of the drum body. The angular displacement of the ribs along their length relative to the drum axis may fall within a broad range of about 0 degrees (i.e. parallel to the drum axis) to about 70 degrees displaced from a line parallel to the drum axis. In general, the average angle of displacement will depend on the expected speed of rotation of the drum and the nature of the drum contents to be processed. This parameter may be determined by routine experimentation.

As seen in FIGS. 1 and 3 through 6, a pair of elongate ribbon-like baffles 40 are mounted to the inside surface of the nose cone 18 extending into the drum interior. The configuration and positioning of the baffles directs the tablets towards the midline of the drum to assist in the tumbling process when the drum is rotated in a first direction to mix and tumble the tablets within the drum, while scooping up and disgorging the contents from the drum in successive drum rotations when the drum is rotated in the opposed direction.

The baffles are fabricated from stainless steel or other rigid inert material, such as 12 or 14 gauge plate. However, it will be seen that while a high degree of rigidity of the baffles is desired, it is not essential to the invention that the baffles be highly rigid. A degree of flexibility is permitted, provided sufficient rigidity is present to permit the baffles to function as described herein.

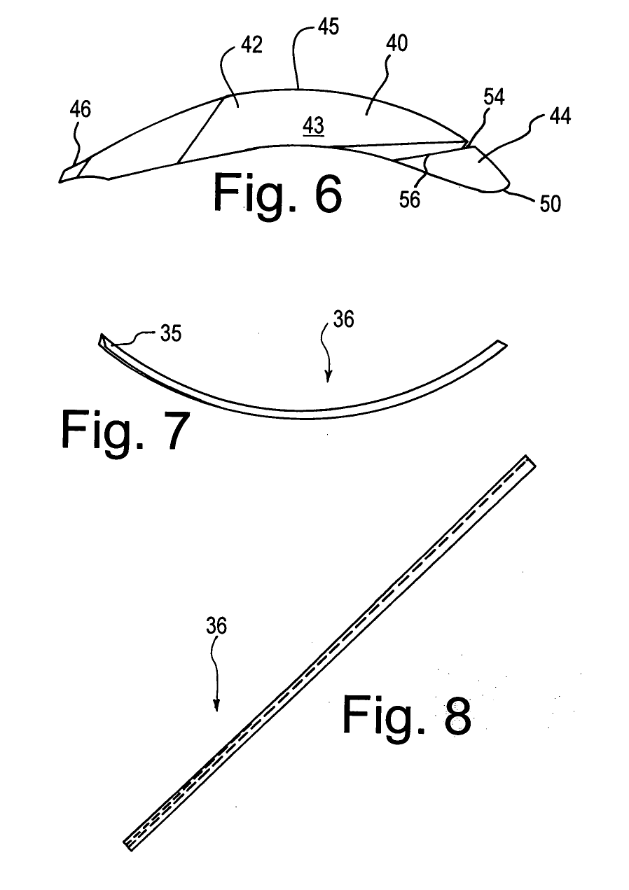

As seen in FIGS. 6, 7 and 8, the baffles 40 have a uniform thickness along their length. The baffles are each comprised of an elongate body region 42 with tip and tail regions 44, 46 at either end. The body region 42 is generally arcuate along its length and also has a twist extending substantially its full length. The degree of twist along the length of the body 42 in the preferred version is about 45°. As will be described below, the twist is generally constant for most of the length of the body region. The degree of twist of the body region 42 along its length may range from about 20 to 90 degrees, with the range being preferably between 40 and 50 degrees. The ribs 40 protrude into the drum interior by a relatively small amount in relation to the overall front-to-rear drum depth. Preferably, the body region 42 has a height of between 2 and 4 inches, although these dimensions are not intended to limit the scope of the invention, so as not to substantially interfere with the tumbling action of the drum during rotation in the first, mixing direction.

The tail region 46 of the baffle 40 is downwardly stepped in height relative to the baffle body 42, as well having as a more pronounced twist in the same direction as the body 42. The pronounced twist of the tail 46 effectively angles the side faces of this region to generally match the angle of the ribs 34, which in combination with the stepped-down height of this region permits the tail region to serve as an effective transition region between the rib 34 and a corresponding baffle 40. The ribs 34 are mounted to communicate with the tail regions 46, such that tablets which are being shifted within the drum by being pushed by the rib 34 are received by the tail region 46 of the baffle 40.

The opposed tip region 44 of the baffle 40 faces the drum opening 22. This tip region 44 is generally flat and platelike. The tip 44 includes a fold 56 which folds the tip inwardly relative to the body in the general direction of curvature of the body 42. The tip region 44 thus effectively forms a flat paddle-like member which partly occludes the drum opening within the collar region 24. The tip 44 terminates in a rounded end 50. A notch 54 marks the junction between the tip 44 and the baffle body 42, which permits the fold 56 to be formed without buckling. This fold 56 is about 65°, but it may reasonably depart from this amount by 20° or more in either direction. The tip 44 serves to direct the drum contents outwardly from the drum, as will be discussed below. The tip 44 may be spaced slightly apart from the interior surface of the collar 24. The end of the tip is generally flush with the collar rim. When the drum 12 is rotated in the second direction to unload the contents of the drum, the angular disposition of the tip 44 helps direct the contents out of the opening of the drum and into a waiting container or discharge chute or the like (not shown).

Mounted within the front nose cone 18 (as seen in FIGS. 3, 4 and 5), is an array comprised of two opposed baffles 40. The baffles 40 are each mounted to the nose cone along a line following generally a chord of the nose cone, such that the elongate axis of each baffle 40 generally follows an imaginary line which is at a bias to the elongate axis of the nose cone of about 45°, although this may range considerably by, for example by up to 20° in either direction. Each baffle 40 extends from its proximal end 46 at the periphery of the nose cone where this meets the drum body 16, to its tip 44 which extends into the collar 24.

Each baffle 40 is mounted to the inside wall of the front nose cone 18 such that a broad face 43 of the baffle is canted slightly towards its concave side. The direction of the cant depends on the selected rotary direction of the drum 12 during the mixing and unloading modes. Thus, the baffle 40 is canted such that when the drum is rotating in the second direction for unloading of tablets from the drum, a broad surface 43 the baffle 40 angles upwardly on the upside (rising) part of its rotary movement. This surface 43 effectively forms a trough to receive the tablets. When the drum is rotating in its reverse direction for tumbling the contents, an opposed broad face 45 of the baffle which is canted downwardly forms the upside (rising) surface of the baffle. This downwardly-canted surface 45 sheds tablets back into the drum interior, while the upwardly-canted surface 43 retains tablets when this forms the upwardly-rising surface. A broad and shallow V-shaped trough is effectively formed between the inside surface of the drum nose cone 18 and the concave side 43 of the baffle 40 during this first direction of rotation. Thus, in the first direction of rotation the baffle 40 has a scooplike effect while in the opposed direction of rotation it does not. The shallow trough permits tablets which have been scooped up by the proximal end 46 of the baffle to slide along the baffle towards the drum mouth. Optionally, the drum 12 may be mounted such that there is a slight tilting of the drum downwardly towards the mouth 18, which permits tablets to slide towards the baffles for removal from the drum.

The baffles 40 are mounted within the interior of the drum 12 such that when the drum is rotated in the first direction, the baffles will tend to direct the contents of the drum away from the opening of the drum to mix and tumble the contents of the drum. When the drum is rotated in the second direction, the baffles 40 direct the contents of the drum towards the opening of the drum to unload the contents of the drum. Each rotation of the drum in this direction deposits a quantity of tablets onto the side surface 35 of the ribs 34. Continued rotation of the drum causes these tablets to slide along a respective rib 34 towards the nose cone 18, by virtue of the biased angle of the ribs 34 which provide them with an auger-like function. The tablets are then deposited on the side surface 43 of a corresponding baffle 40; typically, the baffle 40 receives a charge of tablets as the baffle 40 is traveling upwardly from the lowest point in its rotation. Continued rotation slides the tablets along the surface 43 towards the drum mouth, through the V-shaped trough formed by the surface 43 and the inside surface of the nose cone 18. The tablets slide along this surface 43 until they are discharged outwardly through the drum mouth. As the tablets reach the drum mouth, the tip 44 of the baffle 40 directs the tablets laterally outward through the drum mouth 22, with at least some of the tablets contacting the paddle-like tip.

As seen in FIG. 1, a further array of ribs 42 may optionally be mounted on the inside surface of the rear wall 20, although this second array of ribs may serve only a mixing function.

Although the present invention has been described in the foregoing in part by reference to a detailed description of a particular embodiment, it will be understood by those skilled in this field that the full scope of the invention extends beyond these aspects and is not limited in any respect to any of the features therein described. Rather, the invention in its full scope is characterized by the claims of this specification, including any elements equivalent to any component, feature or element set out in any claim.

1. A mixing or tumbling apparatus for tablets or other loose articles, comprising a drum comprising a generally cylindrical drum wall and front and rear end walls, said front end wall being annular in shape with a central mouth for discharge of the drum contents; and at least one baffle mounted to the inside surface of said front end wall to protrude into the drum interior, said baffle being mounted to said front end wall at a non-radial angle, said baffle comprising a substantially ribbon-like body region with two opposed flat sides and narrow edges, said body region being arcuate and twisted along substantially its full length, said baffle including a proximal end adjacent said drum wall to receive said articles from said drum interior and a distal end adjacent to and partly occluding said central mouth and comprising a paddle-like surface, wherein rotation of said drum in a first direction causes said baffle to push the drum contents inwardly away from said mouth for tumbling of the drum contents while rotation in a second opposed direction causes said baffle to scoop the drum contents from the interior of the drum to slide along a side surface of said front baffle for discharge from said mouth.

2. An apparatus as defined in claim 1, wherein said front end wall is generally conical in shape and protrudes outwardly from said drum.

3. An apparatus as defined in claim 1, further comprising an outwardly protruding collar surrounding said mouth, and said baffle extends at least partly through said collar.

4. An apparatus as defined in claim 1, wherein the distal end of said baffle comprises a flat platelike member which is folded inwardly relative to said body.

5. An apparatus as defined in claim 1, wherein the degree of twist of the body region of said baffle is between 20° and 90°.

6. An apparatus as defined in claim 5, wherein the degree of twist along the length of said baffle is between 40° and 50°.

7. An apparatus as defined in claim 1, further comprising an array of two or more of said baffles.

8. An apparatus as defined in claim 1, wherein said drum wall is perforated.

9. An apparatus as defined in claim 1, wherein said proximal end of said baffle includes a scoop for receiving said drum contents upon rotation of said drum in said second direction.

10. An apparatus as defined in claim 1, further comprising at least one elongate rib mounted to the inside of said cylindrical drum wall at an angle displaced from the elongate axis of said drum for diverting said drum contents towards said baffle during rotation of said drum in said second direction, said rib being mounted in a position such that at least part of said drum contents diverted by said rib are received by said baffle.

11. An apparatus as defined in claim 10 wherein said at least one rib is arcuate.

12. An apparatus as defined in claim 1 further comprising means for supporting and rotating said drum such that its axis of rotation is substantially horizontal, said means comprising a motor, force transfer means to transfer rotary movement of said motor into rotation of said drum, and a reverser to selectively reverse the direction of rotation of said drum upon actuation.

13. A mixing or tumbling apparatus for tablets or other loose articles, comprising a drum comprising a generally cylindrical drum wall and front and rear end walls, said front end wall being annular in shape with a central mouth for discharge of the drum contents; and at least one baffle mounted to the inside surface of said front end wall to protrude into the drum interior, said baffle being mounted to said front end wall at a non-radial angle, said baffle comprising a substantially ribbon-like body region with two opposed flat sides and narrow edges, said body region being arcuate and twisted along substantially its full length, said baffle including a proximal end adjacent said drum wall to receive said articles from said drum interior and a distal end adjacent to and partly occluding said central mouth and comprising a paddle-like surface, wherein rotation of said drum in a first direction causes said baffle to push the drum contents inwardly away from said mouth for tumbling of the drum contents while rotation in a second opposed direction causes said baffle to scoop the drum contents from the interior of the drum to slide along a side surface of said front baffle for discharge from said mouth, and further comprising at least one elongate rib mounted to the inside of said cylindrical drum wall at an angle displaced from the elongate axis of said drum for diverting said drum contents towards said baffle during rotation of said drum in said second direction, said rib being mounted in a position such that at least part of said drum contents diverted by said rib are received by said baffle.

14. An apparatus as defined in claim 13, wherein said front end wall is generally conical in shape and protrudes outwardly from said drum.

15. An apparatus as defined in claim 13, further comprising an outwardly protruding collar surrounding said mouth, and said baffle extends at least partly through said collar.

16. An apparatus as defined in claim 13, wherein the distal end of said baffle comprises a flat platelike member which is folded inwardly relative to said body.

17. An apparatus as defined in claim 13, wherein the degree of twist of the body region of said baffle is between 20° and 90°.

18. An apparatus as defined in claim 17, wherein the degree of twist along the length of said baffle is between 40° and 50°.

19. An apparatus as defined in claim 13, further comprising an array of two or more of said baffles.

20. An apparatus as defined in claim 13, wherein said drum wall is perforated.

21. An apparatus as defined in claim 13, wherein said proximal end of said baffle includes a scoop for receiving said drum contents upon rotation of said drum in said second direction.

22. An apparatus as defined in claim 13 wherein said at least one rib is arcuate.

23. An apparatus as defined in claim 13 further comprising means for supporting and rotating said drum such that the axis of rotation is substantially horizontal, said means comprising a motor, force transfer means to transfer rotary movement of said motor into rotation of said drum, and a reverser to selectively reverse the direction of rotation of said drum upon actuation.
